(19) United States
(12) Patent Application Publication
(10) Pub. No.: US 2018/0093355 A1
(43) Pub. Date: Apr. 5, 2018

(54) ALUMINUM HEAT EXCHANGER

(71) Applicants: DENSO CORPORATION, Kariya-shi, Aichi (JP); UACJ CORPORATION, Tokyo (JP)

(72) Inventors: Hideaki Sato, Kariya-shi (JP); Eizo Takahashi, Kariya-shi (JP); Yasunaga Itoh, Tokyo (JP); Yutaka Yanagawa, Tokyo (JP); Tomoki Yamayoshi, Tokyo (JP)

(73) Assignees: DENSO CORPORATION, Kariya-shi, Aichi (JP); UACJ CORPORATION, Tokyo (JP)

(21) Appl. No.: 15/566,402

(22) PCT Filed: Apr. 18, 2016
(86) PCT No.: PCT/JP2016/062207

§ 371 Date: Oct. 13, 2017

(30) Foreign Application Priority Data
Apr. 28, 2015 (JP) 2015-091103

(51) Int. Cl. B23K 35/28; F28F 21/08

(52) U.S. Cl. CPC B23K 35/286; B32B 15/016; F28F 21/089; F28F 21/084

(57) ABSTRACT

An aluminum heat exchanger is made by disposing an inner fin in a closed space formed by overlapping edge portions of a formed single tube plate or a plurality of formed tube plates, and brazing a first joint obtained by overlapping the edge portions of the tube plate and a second joint obtained by causing the inner fin to abut against the tube plate, wherein an Al—Si-based brazing filler material is interposed at the first and second joints, and brazing is carried out in an inert gas atmosphere without using flux, wherein the inner fin is constituted of a brazing sheet obtained by cladding a core material of an aluminum alloy, on both surfaces thereof, with the Al—Si-based brazing filler material having a solidus temperature of 570° C. or lower, the solidus temperature being lower than a solidus temperature of the Al—Si-based brazing filler material interposed at the first joint.

### TECHNICAL FIELD

The present invention relates to an aluminum heat exchanger in which inner fins are disposed in closed spaces formed by formed tube plates wherein brazing joining is carried out in an inert gas atmosphere without using flux.

### BACKGROUND ART

In aluminum heat exchangers having a large number of fine joining portions, particularly in heat exchangers for automobiles, brazing joining is broadly used as a joining method. In order to brazing join aluminum, it is necessary that an oxide film covering the surface of a brazing filler material should be broken and a molten brazing filler material should be brought into contact with a base material or a similarly molten brazing filler material. Brazing methods involving breaking the oxide film come roughly in two methods of a brazing method using flux in an inert gas atomosphere without applying flux or a brazing method in vacuum.

A method mainly carried out at present as brazing methods of heat exchangers for automobiles is a brazing method involving applying a non-corrosive fluoride-containing flux to aluminum and carrying out brazing in a nitrogen gas. The fluoride flux brazing method is, as compared with a vacuum brazing method, lower in the brazing facility cost, lower in the running cost because of being capable of raising the temperature by heating by a lower electric power, and better in the production efficiency. Further, an anticorrosive treatment utilizing the Zn diffusion is allowed, and thus the fluoride flux brazing method has many advantages: for example, materials for heat exchangers which would be manufactured by a vacuum brazing method can be more reduced in their thickness. Hence, almost all heat exchangers for automobiles produced worldwide at present are produced by a fluoride-containing flux brazing method.

In recent years, problems of heat exchangers for automobiles using fluxes have been highlighted. Size reduction and weight reduction of heat exchangers cause cooling medium passages to become micronized year by year and pose the following problem: residues of fluxes cause the cooling medium passages to be clogged. Further, the cost burden of a step of washing off flux residues with an acid or the like in a step of subjecting the outer surface side of a heat exchanger to a surface treatment has also been seen as a problem. On the other hand, in inverter coolers mounted on hybrid cars, under the apprehension of an adverse influence on electronic components, there are some cases where the vacuum brazing method using no flux is employed. Further, the fluoride-containing fluxes react with Mg in materials to reduce the flux function, and thus have the following disadvantage: the high-strength materials containing Mg cannot be used, which is also an obstacle to further thickness reduction of the materials.

From such a background, as means of solving problematic points of the fluoride-containing flux brazing method and maintaining a high productivity (low cost) and an anticorrosive treatment function of the fluoride-containing flux brazing, developments of brazing methods (commonly called fluxless brazing) of joining in an inert gas atmosphere without using flux have been actively carried out.

In order to carry out brazing joining in an inert gas without applying any flux, it is necessary, for example, that breakage of an oxide film on the surface of a brazing filler material should be promoted and the fluidity of the molten brazing filler should be raised by lowering the surface tension thereof, by actions of components added in materials. Various means have been proposed, for example, adding Mg to a brazing filler material and a core material of a brazing sheet, adding a trace amount of an element high in oxidation tendency, such as Li or Ca to a brazing filler material, or adding Bi to a brazing filler material to improve the fluidity. Further, it is also proposed to remove an oxide film formed on the surface of materials before brazing with an acid solution or an alkali solution to improve the joinability. These means, though enabling easy joining if joints are low in difficulty, commonly have the following problematic points with the fluxless brazing.

For example, tube plates composed of a brazing sheet are formed; edge portions of the formed tube plates are overlapped; and the overlapped edge portions are brazing joined to form a structure having a closed space of a tube, a cup or the like; then, joints obtained by overlapping the edge portions of the tube plates make joints communicating with the exterior and the interior of the tube or the cup, that is, joints whose one sides face the exterior and whose reverse sides face the interior. At this time, when an inner fin is present in the closed space of the interior-side, a molten brazing filler of the joints obtained by overlapping the edge portions of the tube plates is drawn in to joints obtained by causing the inner fin to abut against the tube plates located in the interior; as a result thereof, it becomes difficult for fillets to be formed in the joints on the exterior-side of the tube or the cup.

This is a problem common in fluxless brazing in an inert gas, and in order to promote fillet formation on the exterior-side, a countermeasure of applying a flux on the exterior-side is also taken. However, if materials contain Mg, Mg reacts with the flux to reduce the flux function, and thus a larger amount of the flux is applied, or in order to prevent the decrease in the function due to the reaction with Mg, application of a high-cost flux containing Cs is also carried out, but the brazability on the exterior-side is not stabilized because of the influence of Mg, and this drawback cannot be eliminated. In order to improve the fillet formation capability on the exterior-side, there are a method of raising the purity of an inert gas (lowering the oxygen concentration and the dew point), and also a method of using argon gas, which is more inert than nitrogen gas, and these methods are recognized to have some effect; but these methods are difficult to materialize in production sites in terms of the scale aspect and the cost aspect, and moreover, have failed to exhibit a reliable effect on the fillet formation on the exterior-side of heat exchangers. Thus, the stable formation of fillets on the exterior-side is the problem common in fluxless brazing in an inert gas atmosphere, and is also a greatest factor inhibiting the practical use of the fluxless brazing.

### CITATION LIST

### Patent Literature

[Patent Literature 1] Japanese Patent 2013-233552-A
[Patent Literature 2] Japanese Patent 2014-050861-A
[Patent Literature 3] Japanese Patent 10-180489-A
[Patent Literature 4] Japanese Patent 2014-217844-A

### SUMMARY OF INVENTION

### Technical Problem

An object of the present invention is to provide an aluminum heat exchanger which can solve the above-mentioned problematic points in fluxless brazing and eliminate the defective fillet formation of exterior-side joints due to attraction of a brazing filler from the exterior-side joints located on the outside of the heat exchanger to interior-side joints located in the inside of the heat exchanger, to improve the joinability of each Part of the heat exchanger. Hereinafter, details having led to the present invention will be described. A common problem in fluxless brazing is the defective fillet formation of exterior-side joining portions a (hereinafter, exterior-side joints) (joints 1) obtained by overlapping edge portions 4 of tube plates 2 in a laminated type heat exchanger 1 constituted of the press-formed tube plates 2 and inner fins 3 as illustrated in FIG. 1. The exterior-side defective fillet formation, although being generated also in the case where the brazing atmosphere is bad (for example, the oxygen concentration in the atmosphere is high), even when the brazing atmosphere has no problem, is generated by attraction of a brazing filler to the interior involved in fillet formation of interior-side joining portions b (hereinafter, interior-side joints) (joints 2) obtained by causing the inner fins 3 to abut against the tube plates 2. It is an important point aimed at of the present invention why the attraction of the molten brazing filler to the interior is caused, and the present inventors have paid attention to the temporal progress of the fillet formation in the interior and exterior.

In a joint using an Al—Si brazing filler material, in the case where a flux is applied, the flux melted at about 560° C. causes brisk progress of breakage of not only an oxide film on the brazing filler material surface but also an oxide film of a counterpart material pending the time when 577° C. at which melting of the brazing filler material starts is reached. Hence, as soon as the brazing filler starts to melt, the formation of fillets is initiated at contact points of joints, and the molten brazing filler located at nearest distances is immediately supplied so as to embed gaps of joints and fillets grow soundly (a substantial fillet formation initiation temperature is about 580° C.)

In actual brazing heating of a heat exchanger, in the heat exchanger, fillet formation progresses at exterior-side joints ahead of at interior-side joints by radiant heat transfer from a furnace wall and heat conduction from an atmosphere gas. Also at the interior-side joints whose temperature has been raised slightly later, a process similar to that in the exterior-side joints causes fillet formation to progress by supply of the molten brazing filler located at nearest distances; but in a stage where the temperature has reached the temperature at which the molten brazing filler can freely flow, even if the attraction of the brazing filler into the interior is caused, the fillet formation of the exterior-side joints has already been nearly completed at the stage. So strong attraction as to vanish fillets once formed is a phenomenon generating only in the case where a mechanically severe nonequilibrium is caused, including a large-scale solidification shrinkage of the whole molten brazing filler due to quenching; and in the usual temperature-rise process for brazing, the fillets once formed do not vanish. Therefore, even if the attraction of the brazing filler from the exterior-side to the interior-side is caused along with the growth of fillets of the interior-side joint, only a surplus brazing filler is attracted, and the shape of the fillets soundly formed at the exterior-side joints is maintained.

By contrast, in fluxless brazing without using flux, the breakage of an oxide film on the brazing filler material surface progresses by an action of an added element in materials. During the brazing heating time, the element added to the brazing filler material or a core material diffuses to the brazing filler material surface and promotes the breakage of the oxide film, and thus the breakage of the oxide film on the brazing filler material surface progresses slowly until 577° C. at which the brazing filler melts is reached, and the breakage action on an oxide film of a counterpart material is not exhibited at all. When the brazing filler starts to melt, joining is initiated first at contact points of the exterior-side joints as does for the flux brazing, but the breakage of the oxide film on the brazing filler material surface does not yet sufficiently progress and also the oxide film of the counterpart material is scarcely broken, and thus the growth of fillets of the exterior-side joints (joints 1) results in progressing more slowly than in the flux brazing. When the temperature of the brazing filler on the interior-side reaches its melting temperature slightly later, joining is initiated also at interior-side joints (joints 2).

Presumably, at this time, small spaces of the interior-side are surrounded with aluminum, and oxygen in the atmosphere of the interior-side oxidizes any parts on the aluminum surface of the interior-side, and decreases in amount, and thus the oxide films on the brazing filler material surface of the joining portions and the oxide film of the counterpart material on the interior-side are more vulnerable than those of the exterior-side. Further, the clearances of the interior-side joints (joints 2), due to the feature of the inner fins 3 having elasticity in the height direction, are smaller than those of the exterior-side joints, and are in the state of having substantially almost no gaps. Hence, the breakage of the oxide film on the interior-side more rapidly progresses than that on the exterior-side, and also the growth of fillets of the interior-side joints (joints 2) more rapidly progresses than that on the exterior-side. The rapid fillet growth at the interior-side joints thus causes the attraction of the molten brazing filler into the interior. In a stage where the fillet formation of the exterior-side joints (joints 1) is not yet completed, the molten brazing filler is attracted to the interior, and thus the growth of the fillets of the exterior-side joints (joints 1) stops. As a result, at the exterior-side joints (joints 1), many fillet breaks are generated, and a discontinuous fillet formation state called stitches is noted.

In order to deter the attraction of the molten brazing filler into the interior, in the present invention, it is proposed to constitute the inner fin of a brazing sheet having a low-melting point brazing filler material disposed on both surfaces thereof. According to this constitution, the fillet formation at the interior-side joints is initiated in an earlier stage than that at the exterior-side joints; and in the case where an Al—Si brazing filler material is interposed at the exterior-side joints, at a temperature of 577° C. at which joining is initiated (the substantial joining initiation temperature is about 580° C.), the fillet formation of the interior-side joints (joints 2) results in being nearly completed. As a result, the fillets of the exterior-side joints (joints 1) are enabled to grow soundly without the attraction of the brazing filler into the interior being caused.

In order to initiate the fillet formation at the interior-side joints earlier than on the exterior-side, first, the solidus temperature of the brazing filler material of the inner fin needs to be lowered. With respect to the temperature of the exterior and the interior of usual heat exchangers for automobiles, though depending on the form, the size and the temperature-rise rate of the heat exchangers, the temperature of the exterior is usually higher by 3 to 7° C. than that of the interior, in the melting stage of the brazing filler. The solidus temperature of the Al—Si brazing filler material of the exterior-side joints is 577° C., and thus if a supposed temperature difference between the interior and exterior is estimated at 7° C., it is necessary that the solidus temperature of the brazing filler material disposed on the inner fin should be set to 570° C. or lower.

In order to enable brazing joining in an inert gas atmosphere without using flux, and relatively rapidly progress the fillet formation, as described above, it is necessary that the brazing filler material should contain at least one of Mg, Li and Ca. Further in order to lower the melting point of the Al—Si brazing filler material, the addition of Cu and Zn to the brazing filler material is effective.

### Solution to Problem

The present invention has been achieved from the above findings and the study details; and an aluminum heat exchanger according to claim 1 to achieve the object of the present invention is a heat exchanger made by disposing an inner fin in a closed space formed by overlapping edge portions of a formed single tube plate or a plurality of formed tube plates, and brazing a joint 1 obtained by overlapping the edge portions of the tube plate and a joint 2 obtained by causing the inner fin to abut against the tube plate, wherein an Al—Si-based brazing filler material is interposed at the joint 1 and the joint 2, and brazing is carried out in an inert gas atmosphere without using flux, wherein the inner fin is constituted of a brazing sheet obtained by cladding a core material of an aluminum alloy, on both surfaces thereof, with the Al—Si-based brazing filler material comprising 9 to 13% of Si, one or two or more of 0.2 to 1.2% of Mg, 0.004 to 0.1% of Li and 0.005 to 0.03% of Ca, further one or two of Cu and Zn, with a balance being aluminum and unavoidable impurities, and having a solidus temperature of 570° C. or lower, the solidus temperature being lower than a solidus temperature of the Al—Si-based brazing filler material interposed at the joint 1.

An aluminum heat exchanger according to claim 2 is the heat exchanger of claim 1 wherein the aluminum alloy core material of the brazing sheet constituting the inner fin contains 0.2 to 1.3% of Mg.

An aluminum heat exchanger according to claim 3 is the heat exchanger of claim 1 or 2 wherein the Al—Si-based brazing filler material of the brazing sheet constituting the inner fin contains 0.004 to 0.2% of Bi.

An aluminum heat exchanger according to claim 4 is the heat exchanger of any one of claims 1 to 3, wherein the inner fin is subjected to an etching treatment with an acid solution or an alkali solution before the brazing.

### Advantageous Effects of Invention

There is provided an aluminum heat exchanger made by disposing inner fins in closed spaces formed by overlapping edge portions of a formed single tube plate or a plurality of formed tube plates, and brazing joints 1 obtained by overlapping the edge portions of the tube plates and joints 2 obtained by causing the inner fins to abut against the tube plates, wherein an Al—Si-based brazing filler material is interposed at the joints 1 and the joints 2 each, and brazing is carried out in an inert gas atmosphere without using flux, to enable elimination of the defective fillet formation of the exterior-side joints (joints 1) due to the attraction of the brazing filler from the exterior-side joints (joints 1) located on the outside of the heat exchanger to the interior-side joints (joints 2) located in the inside thereof, to improve the joinability of each part.

### BRIEF DESCRIPTION OF DRAWING

FIG. 1 is a view schematically illustrating a cross-section of the aluminum heat exchanger according to the present invention.

### DESCRIPTION OF EMBODIMENT

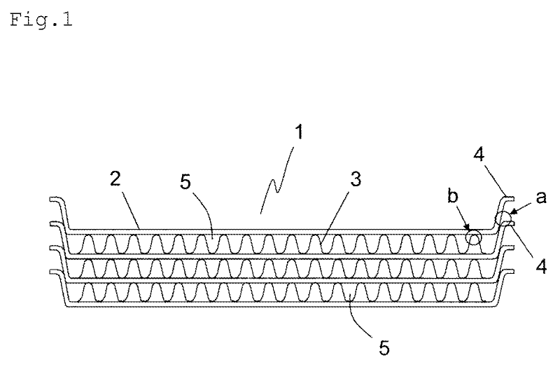

For example, a heat exchanger 1 as illustrated in FIG. 1 corresponds to the heat exchanger according to the present invention, the heat exchanger 1 made by disposing inner fins 3 in closed spaces 5 formed by overlapping edge portions 4 of a plurality of formed tube plates 2, and brazing exterior-side joints (joints 1) obtained by overlapping the edge portions 4 of the tube plates 2 and interior-side joints (joints 2) obtained by causing the inner fins 3 to abut against the tube plates and located in the inner side than the exterior-side joints (joints 1), in an inert gas atmosphere without using flux. Besides, various forms of heat exchangers correspond to the heat exchanger according to the present invention, the heat exchangers having inner fins disposed in closed spaces formed by overlapping edge portions of a formed single tube plate or a plurality of formed tube plates, and having exterior-side joints obtained by overlapping the edge portions of the tube plates and interior-side joints obtained by causing the inner fins to abut against the tube plates, including a heat exchanger having a cooling medium passage pipe made by combining formed tube plates so as to cause concave sides of the formed tube plates to face each other, and disposing and brazing a corrugated inner fin in the interior.

The present invention uses, as the inner fin, an inner fin obtained by cladding a core material of an aluminum alloy with a brazing filler material on both surfaces thereof, and uses, as the tube plate, a tube plate obtained by cladding a core material of an aluminum alloy with a brazing filler material on both surfaces or one surface thereof (on the inner surface thereof in many cases). In a heat exchanger of a form in which a brazing filler of other parts, for example, a brazing filler of a tank header, flows into overlapped edge portions of tube plates, tube plates composed of a material having no clad brazing filler material can also be applied as the tube plates.

The present invention, in order to carry out brazing in an inert gas atmosphere without using flux, needs to adopt, as brazing filler materials for cladding the tube plate and the inner fin, an Al—Si-based brazing filler material containing at least one of 0.2 to 1.2% of Mg, 0.004 to 0.1% of Li and 0.005 to 0.03% of Ca. The incorporation of one or more of Mg, Li and Ca in predetermined amounts in the Al—Si brazing filler material enables brazing joining in an inert gas atmosphere without using flux, and can progress the fillet formation relatively rapidly.

With the content of Mg being lower than 0.2%, the effect of oxide film breakage is poor; and with higher than 1.2%, the surface tension of the molten brazing filler excessively decreases and the fillet formation capability is adversely affected. With the content of Li being lower than 0.004%, the effect of oxide film breakage is poor; and with higher than 0.1%, Li₂O is excessively formed and the joinability becomes poor. With the content of Ca being lower than 0.005%, the effect of oxide film breakage is poor; and with higher than 0.03%, CaO is excessively formed and the joinability becomes poor. Here, with respect to the Mg, Li and Ca, when one or two thereof are added in above-mentioned amounts added to the brazing filler material, even if the other two or one thereof is compositely added in amounts smaller than the lower limit values of the above amounts added, the brazability is never inhibited, and the effect of improving the brazability is exhibited in some cases.

With respect to the Al—Si-based brazing filler material with which the inner fin is clad, it is further necessary that in order to deter the attraction of the molten brazing filler from the exterior-side joints (joints 1) of the heat exchanger to the interior-side joints (joints 2) thereof, the solidus temperature should be 570° C. or lower, and should be set to lower than the solidus temperature of the Al—Si-based brazing filler material interposed at the joints 1. Therefor, the addition of Cu and Zn to the brazing filler material is effective. In order to set the solidus temperature of the Al—Si brazing filler material to 570° C. or lower, in the case of single addition of Cu or Zn, in an Al-10% Si brazing filler material, which is most often used, it is necessary that 0.6% or more of Cu or 3.3% or more of Zn should be added. if Cu and Zn are added concurrently, necessary lower limit values of the respective amounts added become smaller. Here, the amount of Si in the Al—Si-based brazing filler material with which the inner fin is clad, in order to rapidly progress the fillet formation, desirably 9 to 13%, which is a compositional amount near the eutectic composition; in the Al—Si-based brazing filler material having an amount of Si in this range, a practical amount of Cu and/or Zn added in order to set the solidus temperature to 570° C. or lower is approximately, in the case of single addition, 0.5 to 5% of Cu or 3 to 7% of Zn, and in the case of concurrent addition, 0.3 to 4% of Cu and 0.5 to 5% of Zn.

It is also effective that by lowering the liquidus temperature of the brazing filler material with which the inner fin is clad, the fillet formation of the interior-side joints (joints 2) by the brazing filler material of the inner fin is rapidly progressed. The point at this time is the Al—Si-based brazing filler material interposed at the exterior-side joints (joints 1), and a substantial temperature at which the fillet formation is initiated by this brazing filler material is about 580° C., and thus in order to avoid the attraction of the brazing filler into the interior, it is desirable that the fillet formation of the interior-side joints (joints 2) should be completed by the brazing filler material of the inner fin pending 580° C. is reached, and it is desirable that the liquidus temperature of the brazing filler material of the inner fin should be set to 580° C. or lower. Therefor, the addition of Cu and Zn to the brazing filler material is effective.

Although the addition of Cu and Zn to the Al—Si brazing filler material lowers the melting point of the brazing filler material, the liquidus temperature depends greatly on the amount of Si in the brazing filler material. For example, the liquidus temperature of an Al-12.6% Al—Si brazing filler material which has an eutectic composition is 577° C., and there is no need to add Cu or Zn; but in the case of an Al-10% Si brazing filler material most commonly used, in order to set the liquidus temperature to 580° C., it is necessary that in the case of single addition of Cu or Zn, 4.2% or more of Cu or 6.8% or more of Zn should be added. If Cu and Zn are added concurrently, necessary lower limit values of the respective amounts added become smaller.

As described above, the addition of a small amount of Mg to the Al—Si brazing filler material enables fluxless brazing. The addition of Mg also has the effect on the melting point lowering of the Al—Si brazing filler material; but whereas Mg has an action of promoting breakage of the oxide film, excessive addition thereof induces the defective fillet formation by the decrease of the surface tension of the molten brazing filler and the excessive addition thereof to the brazing filler material forms a peculiar oxide on the brazing filler material surface and causes making the oxide film firm on the contrary. Therefore, it is preferable that the addition of Mg should be chiefly aimed at for the purpose of improving the fluxless brazability, and should be auxiliarily carried out in the range not adversely affecting the melting point lowering.

From the above, the inner fin is constituted of a brazing sheet obtained by cladding a core material of an aluminum alloy, on both surfaces thereof, with an Al—Si-based brazing filler material comprising 9 to 13% of Si, one or two or more of 0.2 to 1.2% of Mg, 0.004 to 0.1% of Li and 0.005 to 0.03% of Ca, further one or two of Cu and Zn, with a balance being aluminum and unavoidable impurities, and having a solidus temperature of 570° C. or lower, the solidus temperature being lower than a solidus temperature of the Al—Si-based brazing filler material interposed at the joints 1.

Also the addition of Mg, in addition to Cu and Zn, to the brazing filler material directly affects the melting point lowering of the brazing filler material; and also in the case of the addition thereof to the core material, Mg diffuses in the brazing filler material during brazing heating and gives the effect of lowering the melting point of the brazing filler material. Further, the addition of Mg to the core material effectively acts on the breakage of the oxide film on the brazing filler material surface through the similar diffusion. However, comparing with the case where Mg is added to the brazing filler material, the timing of the oxide film breakage action delays, and thus it is difficult for only the addition of Mg to the core material to achieve the object of the present invention which is to rapidly form fillets at the interior-side joints (joints 2).

The addition of 0.2 to 1.3% of Mg to the core material of the inner fin and the addition of 0.004 to 0.2% of Bi to the brazing filler material of the inner fin can further improve the joinability. The addition of Mg in an addition added of smaller than 0.2% to the core material is poor in the effect of improving the joinability of the inner fin; the addition thereof in an amount of more than 1.3% raises risks of generating erosion by the molten brazing filler, reducing the fillet formation capability of the joining portions, and generating defective joining due to the deformation of the inner fin. Further the addition of Bi in an amount of smaller than 0.004% to the brazing filler material is poor in the effect of improving the joinability of the inner fin; the addition thereof in an amount of more than 0.2% excessively decreases the surface tension and adversely affects the joinability, and makes the oxide film firm and reduces the wettability.

The inner fin material, by being subjected to an etching treatment with an acid solution or an alkali solution before the brazing, can further be raised in the joinability, and can be stabilized in the fillet formation capability.

### EXAMPLES

Hereinafter, Examples according to the present invention will be described comparing with Comparative Examples, and the advantageous effects of the present invention will be demonstrated. Here, these Examples show one embodiment of the present invention, and the present invention is not limited thereto.

Members constituting an aluminum heat exchanger illustrated in FIG. 1 were manufactured by usual methods. By using, as a tube plate material, a brazing sheet of 0.6 mm in thickness obtained by cladding a core material of a 3003 alloy (Al-1.2% Mn) with 7% of an Al-10% Si-0.6% Mg brazing filler material on each of both surfaces of the core material; and the manufactured tube plate material was press formed into a tube shape. By using, as inner fin materials, brazing sheets of 0.2 mm in thickness obtained by cladding a core material of a 3003 alloy (Al-1.2% Mn) with 10% of various types of brazing filler materials as indicated in Tables 1 and 2 on both surfaces of the core material each, and a 3003 alloy (Al-1.2% Mn) veneer of 0.2 mm in thickness; and the manufactured inner fin materials were each formed into a fin shape.

The members after the formation were subjected to a degreasing treatment and part of the inner fin materials was immersed in a 2% hydrofluoric acid solution for 60 seconds to be subjected to an etching treatment. The pretreated members were assembled in a constitution of a heat exchanger illustrated in FIG. 1, and were confined with stainless steel-made jigs. Here, the constitution in the front-back direction of the page plane of the heat exchanger illustrated in FIG. 1 is a tank structure in which laminated tiers are connected, and both ends of the tank are open.

A nitrogen gas furnace composed of a two chamber type furnace equipped with a preheating chamber and a brazing chamber having a connected internal volume of 0.4 was used; and the assembled test example was loaded in the preheating chamber and the brazing chamber in order, and the test example was brazing joined by setting an arrival temperature of the test example at 600° C. The oxygen concentration of the brazing chamber at the finishing time of the heating was 13 to 17 ppm. After the finish of the heating, the test example was cooled down to 550° C. in the preheating chamber and thereafter air cooled outside the furnace.

The central portion of the test example after the brazing was cut and the fillet formation state of exterior-side joints (joints 1) and that of interior-side joints (joints 2) were visually determined. Here, fillets to be determined were all of joints 1 (outer peripheral portion) of the third tier for the exterior-side joints, and all of joints 2 of the third tier in the cut surface for the interior-side joints.

The fillet formation state in the exterior-side joints (joints 1) was evaluated as follows.

◯◯◯: Uniform fillets were formed over the whole periphery.

◯◯: Fillets were formed over the whole periphery, but the fillets were a little small.

◯: Fillets were formed over the whole periphery, but the shape was slightly unstable.

Δ: Fillet breaks were generated.

×: Almost no fillets were formed over the whole periphery.

The fillet formation state in the interior-side joints (joints 2) was evaluated as follows.

◯◯◯: Uniformly and large fillets were formed at all joining portions.

◯◯: Uniformly fillets were formed at all joining portions, but the fillets were a little small.

◯: Fillets were formed at all joining portions, but the size of the fillets was slightly unstable.

Δ: Fillet unformed portions were present.

×: Fillets were unformed at almost all joining portions.

Tables 1 and 2 show components, solidus temperatures, liquidus temperatures and evaluation results of fillet formation states of the brazing filler materials with which the inner fin materials were clad.

TABLE 1

| | Inner Fin Material | | | | | | | | | |
|---|---|---|---|---|---|---|---|---|---|---|
| | | Chemical Composition (mass %) | | | | | | | | |
| test example | Part | Si | Fe | Cu | Mn | Mg | Zn | Li | Ca | Bi |
| 1 | Brazing Filler Material | 10 | — | 1.0 | — | 0.6 | 4.7 | — | — | — |
| | Core Material | — | — | — | 1.2 | — | — | — | — | — |
| | Brazing Filler Material | 10 | — | 1.0 | — | 0.6 | 4.7 | — | — | — |
| 2 | Brazing Filler Material | 10 | — | 2.0 | — | — | 3.0 | 0.01 | — | — |
| | Core Material | — | — | — | 1.2 | — | — | — | — | — |
| | Brazing Filler Material | 10 | — | 2.0 | — | — | 3.0 | 0.01 | — | — |
| 3 | Brazing Filler Material | 10 | — | 0.5 | — | — | 0.5 | 0.01 | — | — |
| | Core Material | — | — | — | 1.2 | — | — | — | — | — |
| | Brazing Filler Material | 10 | — | 0.5 | — | — | 0.5 | 0.01 | — | — |
| 4 | Brazing Filler Material | 11 | — | 1.0 | — | — | 0.5 | 0.01 | — | — |
| | Core Material | — | — | — | 1.2 | — | — | — | — | — |
| | Brazing Filler Material | 11 | — | 1.0 | — | — | 0.5 | 0.01 | — | — |
| 5 | Brazing Filler Material | 10 | — | 4.0 | — | — | — | — | 0.01 | — |
| | Core Material | — | — | — | 1.2 | — | — | — | — | — |
| | Brazing Filler Material | 10 | — | 4.0 | — | — | — | — | 0.01 | — |
| 6 | Brazing Filler Material | 12 | — | — | — | — | 4.0 | 0.01 | 0.008 | — |
| | Core Material | — | — | — | 1.2 | — | — | — | — | — |
| | Brazing Filler Material | 12 | — | — | — | — | 4.0 | 0.01 | 0.008 | — |
| 7 | Brazing Filler Material | 10 | — | 2.0 | — | — | 3.0 | — | 0.01 | — |
| | Core Material | — | — | — | 1.2 | 0.2 | — | — | — | — |
| | Brazing Filler Material | 10 | — | 2.0 | — | — | 3.0 | — | 0.01 | — |
| 8 | Brazing Filler Material | 10 | — | 4.0 | — | — | — | — | 0.01 | — |
| | Core Material | — | — | — | 1.2 | 0.6 | — | — | — | — |
| | Brazing Filler Material | 10 | — | 4.0 | — | — | — | — | 0.01 | — |
| 9 | Brazing Filler Material | 10 | — | 4.0 | — | — | — | — | 0.01 | — |
| | Core Material | — | — | — | 1.2 | 1.3 | — | — | — | — |
| | Brazing Filler Material | 10 | — | 4.0 | — | — | — | — | 0.01 | — |
| 10 | Brazing Filler Material | 10 | — | 4.0 | — | — | — | — | 0.01 | 0.02 |
| | Core Material | — | — | — | 1.2 | — | — | — | — | — |
| | Brazing Filler Material | 10 | — | 4.0 | — | — | — | — | 0.01 | 0.02 |
| 11 | Brazing Filler Material | 10 | — | 4.0 | — | — | — | — | 0.01 | 0.2 |
| | Core Material | — | — | — | 1.2 | — | — | — | — | — |
| | Brazing Filler Material | 10 | — | 4.0 | — | — | — | — | 0.01 | 0.2 |
| 12 | Brazing Filler Material | 10 | — | 2.0 | — | — | 3.0 | 0.01 | — | 0.02 |
| | Core Material | — | — | — | 1.2 | — | — | — | — | — |
| | Brazing Filler Material | 10 | — | 2.0 | — | — | 3.0 | 0.01 | — | 0.02 |
| 13 | Brazing Filler Material | 10 | — | 1.0 | — | 0.2 | 4.7 | — | — | — |
| | Core Material | — | — | — | 1.2 | — | — | — | — | — |
| | Brazing Filler Material | 10 | — | 1.0 | — | 0.2 | 4.7 | — | — | — |
| 14 | Brazing Filler Material | 10 | — | 1.0 | — | 1.2 | 4.7 | — | — | — |
| | Core Material | — | — | — | 1.2 | — | — | — | — | — |
| | Brazing Filler Material | 10 | — | 1.0 | — | 1.2 | 4.7 | — | — | — |
| 15 | Brazing Filler Material | 10 | — | 2.0 | — | — | 3.0 | 0.004 | — | — |
| | Core Material | — | — | — | 1.2 | — | — | — | — | — |
| | Brazing Filler Material | 10 | — | 2.0 | — | — | 3.0 | 0.004 | — | — |
| 16 | Brazing Filler Material | 10 | — | 2.0 | — | — | 3.0 | 0.1 | — | — |
| | Core Material | — | — | — | 1.2 | — | — | — | — | — |
| | Brazing Filler Material | 10 | — | 2.0 | — | — | 3.0 | 0.1 | — | — |
| 17 | Brazing Filler Material | 10 | — | 4.0 | — | — | — | — | 0.005 | — |
| | Core Material | — | — | — | 1.2 | — | — | — | — | — |
| | Brazing Filler Material | 10 | — | 4.0 | — | — | — | — | 0.005 | — |
| 18 | Brazing Filler Material | 10 | — | 4.0 | — | — | — | — | 0.03 | — |
| | Core Material | — | — | — | 1.2 | — | — | — | — | — |
| | Brazing Filler Material | 10 | — | 4.0 | — | — | — | — | 0.03 | — |

| | Inner Fin Marerial | | | | |
|---|---|---|---|---|---|
| | Melting Point of | | | | |
| | Brazing filler material | | | Evaluation | |
| | (° C.) | | | Exterior- | Interior- |
| | | Liquidus | | Side | Side |
| test example | Solidus Temperature | Temperature | Pretreatment | Joint Fillet | Joint Fillet |
| 1 | 555 | 580 | Degreasing | ◯◯ | ◯◯ |
| 2 | 545 | 580 | Degreasing | ◯◯ | ◯◯ |
| 3 | 570 | 592 | Degreasing | ◯ | ◯◯ |
| 4 | 569 | 581 | Degreasing | ◯◯ | ◯◯ |
| 5 | 535 | 580 | Degreasing | ◯◯ | ◯ |
| 6 | 567 | 573 | Degreasing | ◯◯◯ | ◯◯◯ |
| 7 | 545 | 580 | Degreasing | ◯◯ | ◯◯ |
| 8 | 545 | 580 | Degreasing | ◯◯ | ◯◯◯ |
| 9 | 545 | 580 | Degreasing | ◯◯ | ◯◯ |
| 10 | 535 | 580 | Degreasing | ◯◯ | ◯◯ |
| 11 | 535 | 580 | Degreasing | ◯◯ | ◯◯ |
| 12 | 545 | 580 | Degreasing + | ◯◯ | ◯◯◯ |
| | | | Etching | | |
| 13 | 553 | 578 | Degreasing | ◯◯ | ◯ |
| 14 | 547 | 575 | Degreasing | ◯◯◯ | ◯ |
| 15 | 545 | 580 | Degreasing | ◯◯ | ◯ |
| 16 | 545 | 580 | Degreasing | ◯◯ | ◯ |
| 17 | 535 | 580 | Degreasing | ◯◯ | ◯ |
| 18 | 535 | 580 | Degreasing | ◯◯ | ◯ |

TABLE 2

| | Inner Fin Marerial | | | | | | | | | |
|---|---|---|---|---|---|---|---|---|---|---|
| | | Chemical Composition (mass %) | | | | | | | | |
| test example | Part | Si | Fe | Cu | Mn | Mg | Zn | Li | Ca | Bi |
| 19 | Veneer | — | — | — | 1.2 | — | — | — | — | — |
| 20 | Brazing Filler Material | 10 | — | 1.0 | — | 0.1 | 4.7 | — | — | — |
| | Core Material | — | — | — | 1.2 | — | — | — | — | — |
| | Brazing Filler Material | 10 | — | 1.0 | — | 0.1 | 4.7 | — | — | — |
| 21 | Brazing Filler Material | 10 | — | 1.0 | — | 1.5 | 4.7 | — | — | — |
| | Core Material | — | — | — | 1.2 | — | — | — | — | — |
| | Brazing Filler Material | 10 | — | 1.0 | — | 1.5 | 4.7 | — | — | — |
| 22 | Brazing Filler Material | 10 | — | 2.0 | — | — | 3.0 | 0.002 | — | — |
| | Core Material | — | — | — | 1.2 | — | — | — | — | — |
| | Brazing Filler Material | 10 | — | 2.0 | — | — | 3.0 | 0.002 | — | — |
| 23 | Brazing Filler Material | 10 | — | 2.0 | — | — | 3.0 | 0.15 | — | — |
| | Core Material | — | — | — | 1.2 | — | — | — | — | — |
| | Brazing Filler Material | 10 | — | 2.0 | — | — | 3.0 | 0.15 | — | — |
| 24 | Brazing Filler Material | 10 | — | 4.0 | — | — | — | — | 0.002 | — |
| | Core Material | — | — | — | 1.2 | — | — | — | — | — |
| | Brazing Filler Material | 10 | — | 4.0 | — | — | — | — | 0.002 | — |
| 25 | Brazing Filler Material | 10 | — | 4.0 | — | — | — | — | 0.06 | — |
| | Core Material | — | — | — | 1.2 | — | — | — | — | — |
| | Brazing Filler Material | 10 | — | 4.0 | — | — | — | — | 0.06 | — |
| 26 | Brazing Filler Material | 10 | — | — | — | — | 0.5 | 0.01 | — | — |
| | Core Material | — | — | — | 1.2 | — | — | — | — | — |
| | Brazing Filler Material | 10 | — | — | — | — | 0.5 | 0.01 | — | — |
| 27 | Brazing Filler Material | 10 | — | 4.0 | — | — | — | — | 0.01 | — |
| | Core Material | — | — | — | 1.2 | 1.6 | — | — | — | — |
| | Brazing Filler Material | 10 | — | 4.0 | — | — | — | — | 0.01 | — |
| 28 | Brazing Filler Material | 10 | — | 4.0 | — | — | — | — | 0.01 | 0.4 |
| | Core Material | — | — | — | 1.2 | — | — | — | — | — |
| | Brazing Filler Material | 10 | — | 4.0 | — | — | — | — | 0.01 | 0.4 |
| 29 | Brazing Filler Material | 10 | — | 4.0 | — | — | — | — | 0.01 | — |
| | Core Material | — | — | — | 1.2 | 0.1 | — | — | — | — |
| | Brazing Filler Material | 10 | — | 4.0 | — | — | — | — | 0.01 | — |
| 30 | Brazing Filler Material | 10 | — | 4.0 | — | — | — | — | 0.01 | 0.002 |
| | Core Material | — | — | — | 1.2 | — | — | — | — | — |
| | Brazing Filler Material | 10 | — | 4.0 | — | — | — | — | 0.01 | 0.002 |

| | Inner Fin Marerial | | | | |
|---|---|---|---|---|---|
| | Melting Point of | | | | |
| | Brazing filler material | | | | |
| | (° C.) | | | Evaluation | |
| | | Liquidus | | Exterior-Side | Interior-Side |
| test example | Solidus Temperature | Temperature | Pretreatment | Joint Fillet | Joint Fillet |
| 19 | — | — | Degreasing | Δ | ◯◯ |
| 20 | 555 | 580 | Degreasing | Δ | ◯◯ |
| 21 | 549 | 577 | Degreasing | Δ | ◯ |
| 22 | 545 | 580 | Degreasing | Δ | ◯◯ |
| 23 | 545 | 580 | Degreasing | Δ | ◯ |
| 24 | 535 | 580 | Degreasing | Δ | ◯◯ |
| 25 | 535 | 580 | Degreasing | Δ | ◯ |
| 26 | 575 | 594 | Degreasing | Δ | ◯◯ |
| 27 | 555 | 580 | Degreasing | ◯◯ | Δ |
| 28 | 555 | 580 | Degreasing | ◯◯ | Δ |
| 29 | 535 | 580 | Degreasing | ◯◯ | ◯ |
| 30 | 535 | 580 | Degreasing | ◯◯ | ◯ |

As shown in Table 1, in any of the test examples 1 to 18 made according to the present invention, the brazing filler materials of the inner fins early initiated melting and formed fillets preferentially at the interior-side joints, and thus the attraction force from the exterior-side joints to the interior weakened, and as a result, continuous fillets were formed at the exterior-side joints (joints 1).

It was determined that the test example 3, in which the liquidus temperature of the brazing filler material was as high as 592° C. but the solidus temperature was as low as 570° C., initiated the fillet formation at the interior-side joints at the early stage, which reduced the attraction force of the brazing filler from the exterior-side joints to the interior. In the test example 6, in which the liquidus temperature was lowered by setting the amount of Si in the brazing filler material to 12%, the attraction force of the molten brazing filler into the interior vanished and the fillet formation of the exterior-side joints was remarkably soundly carried out. Further, also at the interior-side joints, large fillets were stably formed.

In the test examples 7 to 10, the addition of Mg to the core materials of the inner fins or the addition of Bi to the brazing filler materials improved the fillet formation capability at the interior-side joints. In the test example 12, the effect of the etching treatment brought about the improvement of the fillet formation capability at the interior-side joints. In the test example 14, the lowering of the liquidus temperature of the brazing filler material of the inner fin improved the fillet formation capability at the exterior-side joints. However, the amount of Mg added to the brazing filler material of the inner fin was large, and thus the fillet formation capability of the interior-side joints was slightly adversely affected.

By contrast, as shown in Table 2, in the test example 19 using a bare 3003 alloy as the inner fin material, the brazing filler of the exterior-side joints was attracted to the interior and fillets were formed at the interior-side joints; as a result, the brazing filler of the exterior-side joints became insufficient and fillet breaks were caused at the exterior-side joints. In the test examples 20, 22 and 24, although the brazing filler materials of the inner fins initiated melting in the early stage, the breaking capability of the oxide film became insufficient, and thus fillets could not be formed at the interior-side joints; as a result, substantially as was for the test example 19, the brazing filler of the exterior-side joints was attracted to the interior and fillet breaks were caused at the exterior-side joints.

In the test example 21, the excessive addition of Mg to the brazing filler material of the inner fin made minimum the fillet formation at the interior-side joints by the brazing filler of the inner fin; resultantly, the brazing filler of the exterior-side joints was attracted to the interior and the fillets were formed at the interior-side joint, and fillet breaks were caused at the exterior-side joints. In the test examples 23 and 25, the excessive addition of Li or Ca to the brazing filler materials of the inner fins made firm the oxide film of the brazing filler materials of the inner fins, and the fillets could not be formed though the melting was initiated in the early stage; as a result, the brazing filler of the exterior-side joints was attracted to the interior and fillet breaks were caused at the exterior-side joints. In the test example 26, in which the solidus temperature of the brazing filler material of the inner fin was high, substantially as was for the test example 19, the brazing filler of the exterior-side joints was attracted to the interior and fillet breaks were caused at the exterior-side joints.

In the test example 27, the excessive addition of Mg to the core material of the inner fin generated erosion and generated unformed portions of fillets due to the deformation of the inner fin. In the test example 28, the excessive addition of Bi to the brazing filler material of the inner fin made the oxide film firm and inhibited the fillet formation of the interior-side joints. The test examples 29 and 30 were shown as references; and the test example 29, in which the amount of Mg added to the core material of the inner fin was small, gave no discernible improvement effect as compared with the test example 5 shown in Table 1. Further the test example 30, in which the amount of Bi added to the brazing filler material of the inner fin was small, gave no discernible improvement effect as compared with the test example 5 shown in Table 1.

### REFERENCE SIGNS LIST

1 ALUMINUM HEAT EXCHANGER
2 TUBE PLATE
3 INNER FIN
4 EDGE PORTION OF TUBE PLATE
5 CLOSED SPACE
a EXTERIOR-SIDE JOINT (JOINT 1)
b INTERIOR-SIDE JOINT (JOINT 2)

1. An aluminum heat exchanger made by disposing an inner fin in a closed space formed by overlapping edge portions of a formed single tube plate or a plurality of foliated tube plates, and brazing a first joint obtained by overlapping the edge portions of the tube plate and a second joint obtained by causing the inner fin to abut against the tube plate, wherein an Al—Si-based brazing filler material is interposed at the first joint and the second joint, and brazing is carried out in an inert gas atmosphere without using flux, wherein the inner fin is constituted of a brazing sheet obtained by cladding a core material of an aluminum alloy, on both surfaces thereof, with the Al—Si-based brazing filler material comprising 9 to 13% of Si, one or two or more of 0.2 to 1.2% of Mg, 0.004 to 0.1% of Li and 0.005 to 0.03% of Ca, further one or two of Cu and Zn, with a balance being aluminum and unavoidable impurities, and having a solidus temperature of 570° C. or lower, the solidus temperature being lower than a solidus temperature of the Al—Si-based brazing filler material interposed at the first joint.

2. The aluminum heat exchanger according to claim 1, wherein the aluminum alloy core material of the brazing sheet constituting the inner fin comprises 0.2 to 1.3% of Mg.

3. The aluminum heat exchanger according to claim 1, wherein the Al—Si-based brazing filler material of the brazing sheet constituting the inner fin comprises 0.004 to 0.2% of Bi.

4. The aluminum heat exchanger according to claim 1, wherein the inner fin is subjected to an etching treatment with an acid solution or an alkali solution before the brazing.

5. The aluminum heat exchanger according to claim 2, wherein the Al—Si-based brazing filler material of the brazing sheet constituting the inner fin comprises 0.004 to 0.2% of Bi.

6. The aluminum heat exchanger according to claim 2, wherein the inner fin is subjected to an etching treatment with an acid solution or an alkali solution before the brazing.

7. The aluminum heat exchanger according to claim 3, wherein the inner fin is subjected to an etching treatment with an acid solution or an alkali solution before the brazing.
